(19) United States
(12) Patent Application Publication
(10) Pub. No.: US 2008/0198242 A1
(43) Pub. Date: Aug. 21, 2008

(54) Data storage device with camera function

(76) Inventor: Ho-Lung Lu, Panchiao (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/707,979

(22) Filed: Feb. 20, 2007

(51) Int. Cl. H04N 5/76

(52) U.S. Cl. 348/231.9; 348/E09.002

(57) ABSTRACT

A data storage device with a camera function comprises a device body, a camera unit, and a storage unit. One side of the device body is formed with a first electrical connector, the camera unit is provided in the device body, and the storage unit is provided in the device body. Thus, this invention features data storage and camera functions so that a single connection port can be used for both functions, a limited number of connection ports can be used effectively, the inconvenience of having to separate purchase a camera and a data storage device is avoided, and expenses and storage space can be reduced.

### BACKGROUND OF THE INVENTION

1. Field of the Invention

This invention relates to a data storage device with a camera function and particularly to a data storage device in which a camera unit is installed.

2. Description of Related Art

Owing to intense competition of 3C products (computers, communication devices, and consumer electronic products) and along with the upgrade of the related technology, consumers are more than ever demanding 3C products that offer a wide range of functions and interoperability. If lacking integrated functions, 3C products might be eliminated from market through competition, thereby impacting the profits of the industry.

A conventional data storage device, such as a portable storage drive doesn't include a camera and is usually used only for data storage. A digital camera must be portable to meet the needs of most consumers. Any portable electronic product requires and occupies a connection port of an electronic device, while a conventional data storage device must be inserted into another connection port of an electronic device, such as a notebook. Currently, there are various computer peripherals, so each connection port must be properly used. If a peripheral device with only one function occupies a connection port, the benefit of its utilization is lower and the device affects the utilization of other peripheral devices. This does not meet the requirements of current 3C products with integrated functions.

Hence, the inventor of the present invention believe that the shortcomings described above are able to be improved and finally suggest the present invention which is of a reasonable design and is an effective improvement based on deep research and thought.

### SUMMARY OF THE INVENTION

It is a main object of the present invention to provide a data storage device with a camera so that the functions of the camera and that of data storage can be integrated to reduce the amount of connection ports used and prevent the inconvenience caused by having to separately purchase a camera device and a data storage device.

In order to achieve the object mentioned above, this invention provides the data storage device with a camera, comprising:

a device body, one side of which is formed with a first electrical connector;

a camera unit in the device body; and

a storage unit in the device body.

This invention has the an advantage integrating the data storage and camera functions so that a single connection port can be used for both functions, a limited amount of connection ports can be used effectively, while the inconvenience of having to separately purchase a camera device and a data storage device is avoided, thereby reducing expenses and the required storage space.

A rotation connector is provided on the device body. The rotation connector can be rotated and bent for users to adjust the device body at a desired angle or to a particular orientation, thereby allowing the camera to precisely capture an image.

In order to further know the features and technical means of the present invention, please refer to the detailed description according to this invention accompanied by drawings. The accompanied drawings are provided for reference and illustration only and are not intended to limit this invention.

### BRIEF DESCRIPTION OF THE DRAWINGS

FIG. 1 is a schematic structural view of a first embodiment of the present invention;

FIG. 2 is a schematic view illustrating the operation of the first embodiment of the present invention (1);

FIG. 3 is a schematic view illustrating the operation of the first embodiment of the present invention (2);

FIG. 4 is a schematic view illustrating the first embodiment of the present invention when in use (1);

FIG. 5 is a schematic view illustrating the first embodiment of the present invention when in use (2);

FIG. 6 is a schematic view illustrating the first embodiment of the present invention when in use (3);

FIG. 7 is a schematic structural view of a second embodiment of the present invention;

FIG. 8 is a schematic structural view of a third embodiment of the present invention;

FIG. 9 is a schematic view illustrating the fourth embodiment of the present invention when in use (1);

FIG. 10 is a schematic view illustrating the fourth embodiment of the present invention when in use (2);

FIG. 11 is a schematic view illustrating the fourth embodiment of the present invention when in use (3); and

FIG. 12 is a schematic view illustrating the fourth embodiment of the present invention when in use (4).

### DETAILED DESCRIPTION OF THE PREFERRED EMBODIMENTS

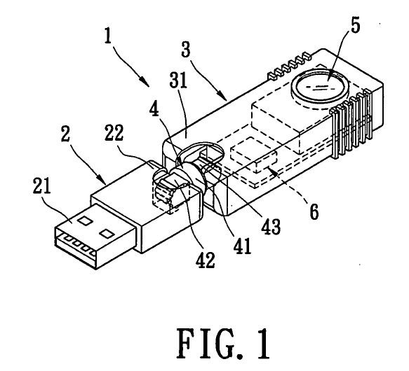

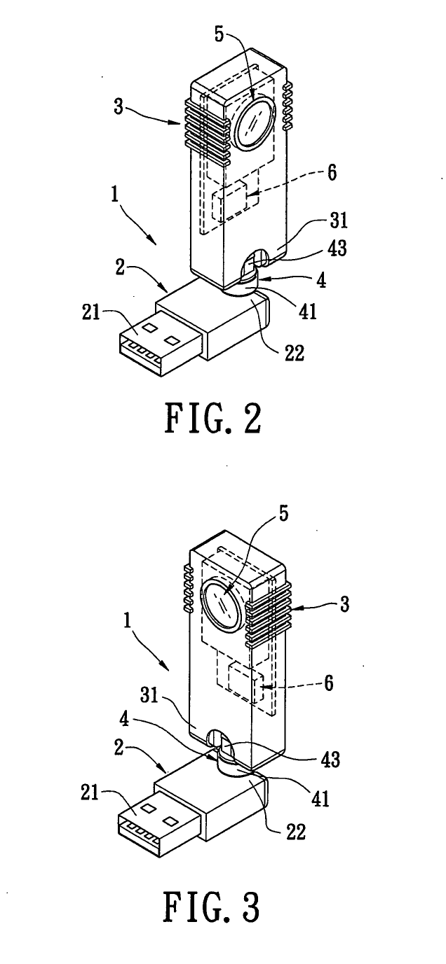

A data storage device with a camera function is provided in this invention. Please refer to FIGS. 1-3 illustrating a first embodiment of the present invention, comprising a device body 1, a camera unit 5, and a storage unit 6. The device body 1 comprises a fixing seat 2, a movable base 3, and a rotation connector 4.

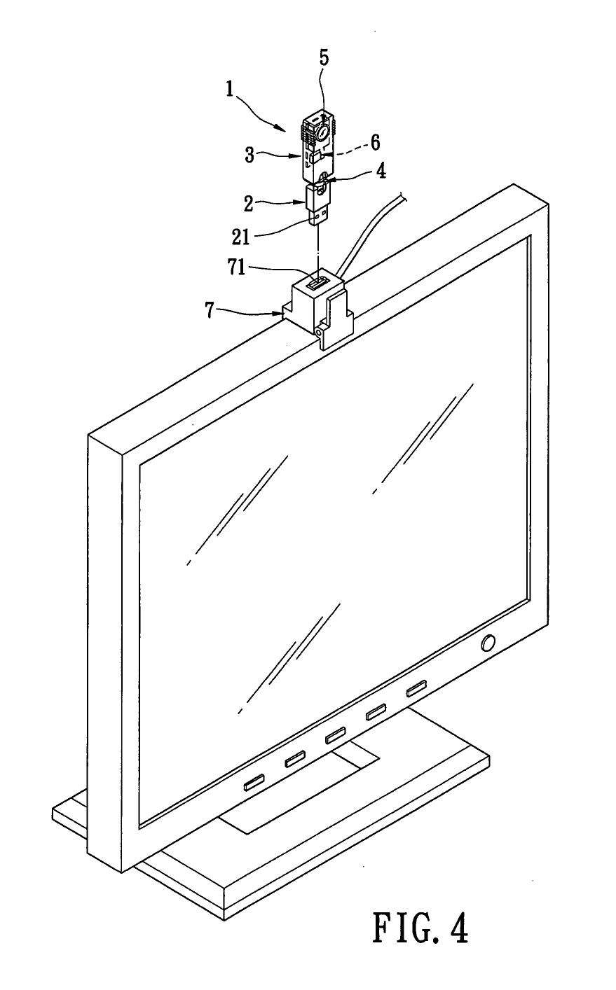

With reference to FIG. 4 (and also FIGS. 1-3), one side of the fixing seat 2 is formed with a first electrical connector 21 that serves as a male plug for a USB interface and electrically connects to an adaptor 7 that has a fourth electrical connector 71 for the first electrical connector 21 to be plugged into and serves as a clamp that electrically connects to a PC, or the like, as an electronic product and transmits data, in which the clamp is clamped on a top portion or another one of an LCD of a PC. The device body 1 can be securely clamped with the clamp onto the LCD for the camera unit 5 to capture an image. One side of the fixing seat 2 is formed with a first connecting portion 22 that can be pivoted to the rotation connector 4.

The camera unit 5 is built in the movable base 3 and for a user to capture an image. One side of the movable base 3 is formed with a second connecting portion 31 that pivots to the rotation connector 4.

The rotation connector 4 can be a universal joint that has a rotation shaft 41, a first pivoting workpiece 42, and a second pivoting workpiece 43. The rotation shaft 41 is in the form of a disk. Axis at two sides of the rotation shaft 41 can be separately pivoted to the first pivoting workpiece 42 and the second pivoting workpiece 43. Each of the first pivoting workpiece 42 and the second pivoting workpiece 43 can rotate 360 degrees on the axis of the rotation shaft 41. The other side of the first pivoting workpiece 42 is pivoted to the first connecting portion 22. The fixing seat 2 revolves to an angle 180 degrees through the first connecting portion 22 on the other side of the first pivoting workpiece 42. The other side of the second pivoting workpiece 43 is pivoted to the second connecting portion 31. The movable base 3 revolves to an angle of 180 degrees through the second connecting portion 31 on the other side of the second pivoting workpiece 43. Thus, the camera 5 on the movable base 3 can be adjusted to any angle or to any orientation that the user desires so that the camera unit 5 may precisely aim at an object the user wants to take a picture of.

The storage unit 6 is built in the fixing seat 2 or the movable base 3, and electrically connects to the clamp through the first electrical connector 21, and further stores and transmits data to the PC or the similar electronic devices.

Before being used, the clamp needs to be clamped to the top edge, side, or another adequate site of the computer display. The first electrical connector 21 on the fixing seat 2 is inserted into the fourth electrical connector 71 of the clamp, the camera unit 5 on the movable base 3 is adjusted to a proper angle or to a proper orientation, and thus the camera unit 5 is readied to aim at an object to capture. After the image has been captured and stored in the storage unit 6, the first electrical connector 21 of the device body 1 can be pulled out of the fourth electrical connector 71 of the clamp and then inserted into the electrical connector of another electronic product for data storage and transmission.

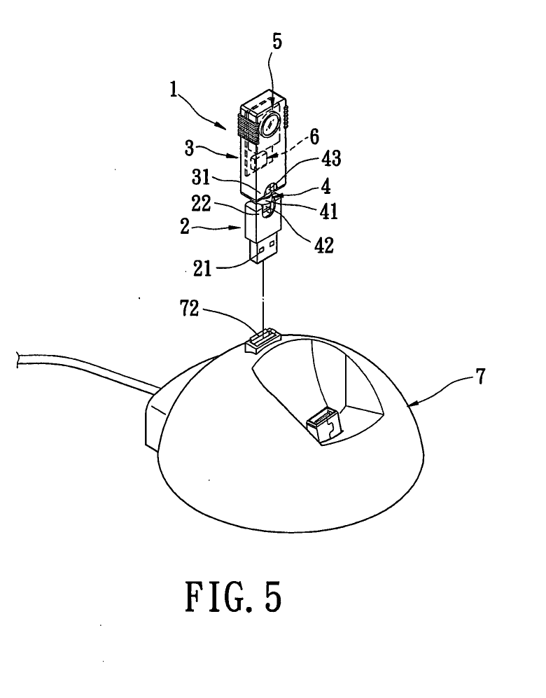

With reference to FIG. 5, the adaptor 7 can be a wireless mouse charging base electrically connected to the PC. A fifth electrical connector 72 is provided on the wireless mouse charging base. The first electrical connector 21 of the fixing seat 2 can be inserted for electrical connection to the fifth electrical connector 72 of the wireless mouse charging base to transmit the image-based or file-based data stored in the storage unit 6 to an electronic device, such as a PC. Thus, from the description above, a benefit identical to that brought in the first embodiment can be realized.

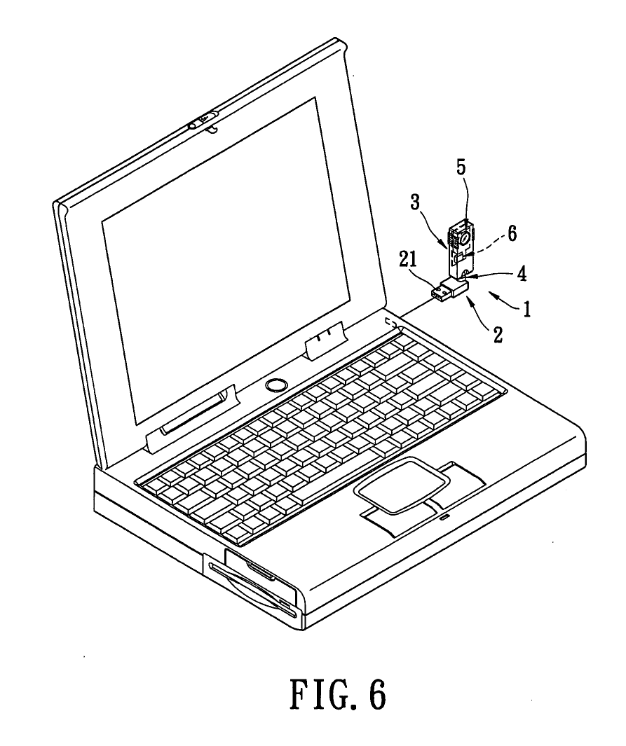

With reference to FIG. 6, the present invention may be inserted into a notebook or the like as a portable electronic product.

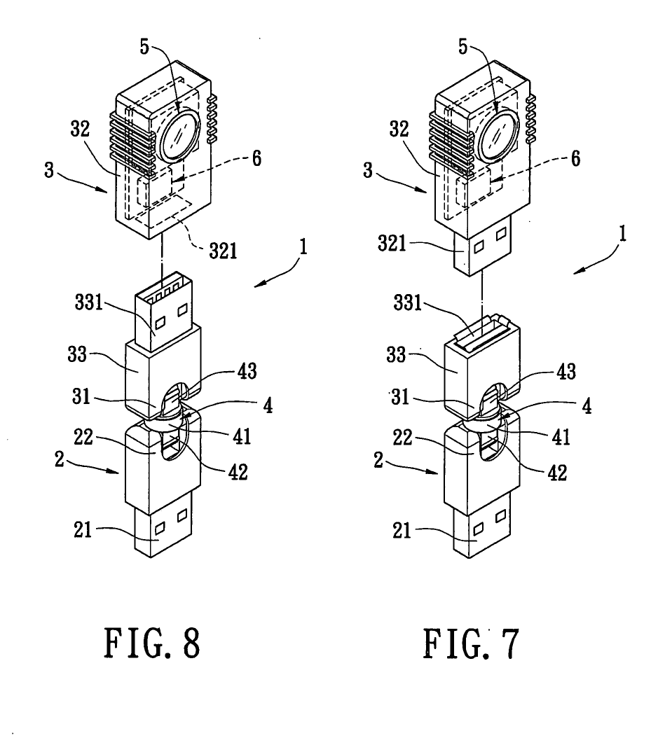

Referring to FIG. 7, a second embodiment of the present invention can be observed. The movable base 3 has a first movable part 32 and a second movable part 33. The first movable part 32 has a second electrical connector 321 serving as a plug for the USB interface, while the second movable part 33 has a third electrical connector 331 serving as a connection port for the USB interface. The second electrical connector 321 is inserted for electrical connection opposite to the third electrical connector 331. The storage unit 6 can be disposed in the fixing seat 3, the first movable part 32, and the second movable part 33. Images captured by the camera unit 5 and the data stored in the storage unit 6 can be transmitted to the notebook or another electronic product through the third electrical connector 331, the second electrical connector 321, and the first electrical connector 21 that are electrically connected to the adaptor 7.

Referring to FIG. 8, a third embodiment of the present invention can be observed. The second electrical connector 321 can be a connection port for the USB interface, while the third electrical connector 331 can be a plug for the USB interface. The first electrical connector 21, the second electrical connector 321, the third electrical connector 331, the fourth electrical connector 71, and the fifth electrical connector 72 can be a USB interface or an IEEE1394 interface. When they are being used, a plug or a connection port can be selected for electrical connection to the electronic product, thereby preventing the electrical connectors from failure to connect to each other.

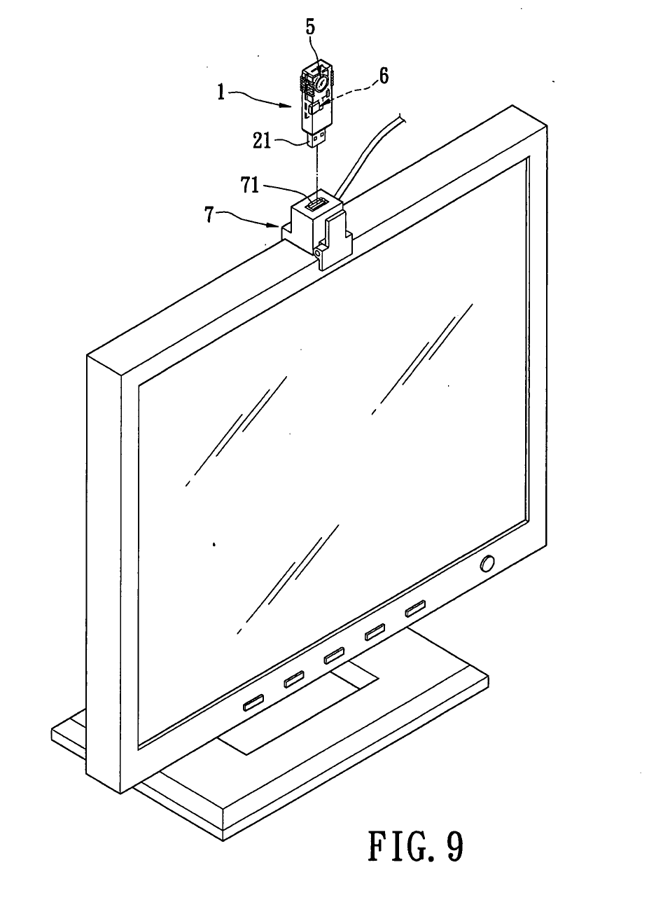

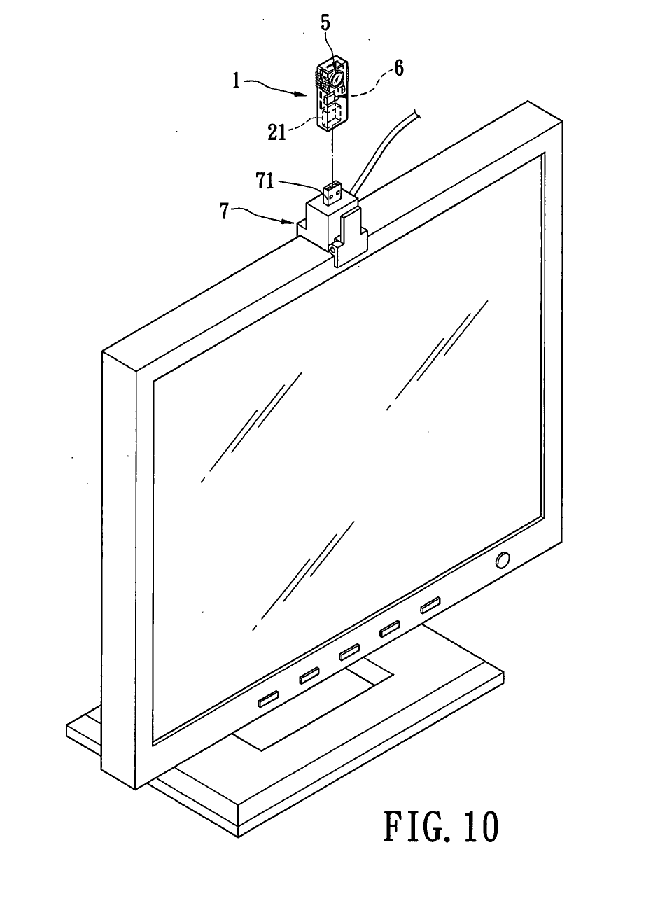

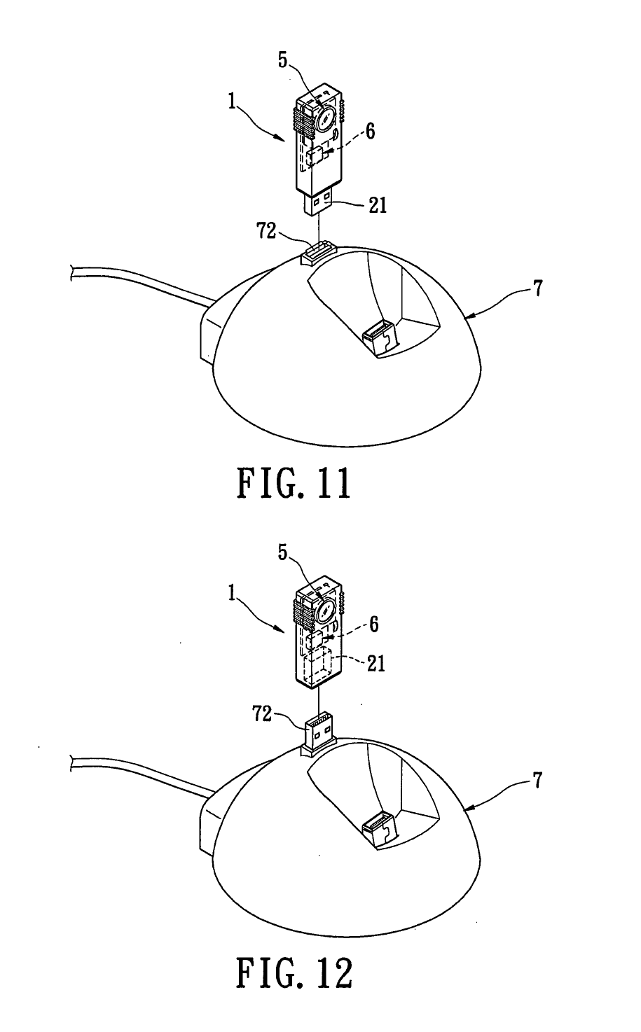

Referring to FIGS. 9-12, a fourth embodiment of the present invention is shown. The device body 1 can be alternatively a single design. The camera unit 5 or the storage unit 6 are directly built in the device body 1, one side of which is formed with the first electrical connector 21 that can be the plug or connection port for a USB interface to electrically connect to the adaptor 7 that is the clamp or the mouse charging base. The first electrical connector 21 can be inserted into the fourth electrical connector 71 of the clamp and the fifth electrical connector 72 of the mouse charging base to connect to an electronic device, such as a notebook or a PC, for data storage and transmission.

This invention has the advantage of integrating data storage and camera functions so that a single connection port of an electronic device, such as a notebook or a PC can be used for both functions, a limited number of connection ports can be used effectively, the inconvenience of having to separate purchase a camera device and a data storage device is prevented, and expenses and storage space can be reduced.

Furthermore, a rotation connector 4 is provided on the device body 1 and can be rotated and bent so that a user can adjust the device body 1 to a desired angle or to an orientation, thereby making the camera unit 5 capture images precisely.

However, in the description mentioned above, only the preferred embodiments according to this invention are without limit to claims of the present invention; all those skilled in the art without exception should include the equivalent changes and modifications as falling within the true scope and spirit of the present invention.

What is claimed is:

1. A data storage device with a camera function, comprising:
a device body comprising a fixing seat, a movable base, and a rotation connector, in which one side of the fixing seat is formed with a first electrical connector and the rotation connector is connected between the fixing seat and the movable base;
a camera unit wedged into the movable base; and
a storage unit provided in the device body.

2. The data storage device with a camera function according to claim 1, wherein the movable base has a first movable part and a second movable part, the first movable part has a second electrical connector, the second movable part has a third electrical connector, and the second electrical connector of the first movable part is inserted into the third electrical connector of the second movable part.

3. The data storage device with a camera function according to claim 2, wherein the first electrical connector, the second electrical connector, and the third electrical connector can be a USB interface or an IEEE1394 interface.

4. The data storage device with a camera function according to claim 2, wherein the camera unit is built in the first movable part.

5. The data storage device with a camera function according to claim 1, wherein the rotation connector is a universal joint.

6. The data storage device with a camera function according to claim 1, wherein the rotation connector has a first pivoting workpiece, a second pivoting workpiece, and a rotation shaft of which two ends are respectively pivoted to the first pivoting workpiece and the second pivoting workpiece.

7. The data storage device with a camera function according to claim 6, wherein one side of the fixing seat is formed with a first connecting portion and a first pivoting workpiece of the rotation connector is pivoted to a first connecting portion of the fixing seat.

8. The data storage device with a camera function according to claim 6, wherein one side of the movable base is formed with a second connecting portion and a second pivoting workpiece of the rotation connector is pivoted to a second connecting portion of the movable base.

9. The data storage device with a camera function according to claim 1, wherein the first electrical connector is an adaptor.

10. The data storage device with a camera function according to claim 1, wherein the storage unit is built in the fixing seat or the movable base.

11. A data storage device with a camera function, comprising:
a device body of which one side is formed with a first electrical connector;
a camera unit provided in the device body; and
a storage unit provided in the device body.

12. The data storage device with a camera function according to claim 11, wherein the first electrical connector is a USB interface or an IEEE1394 interface.

13. The data storage device with a camera function according to claim 11, wherein the first electrical connector is an adaptor.
